(19) United States
(12) Patent Application Publication
(10) Pub. No.: US 2015/0361326 A1
(43) Pub. Date: Dec. 17, 2015

(54) WELL TREATMENT FLUID MATERIAL AND WELL TREATMENT FLUID COMPRISING THE SAME

(71) Applicant: KUREHA CORPORATION, Tokyo (JP)

(72) Inventors: TAKASHI MASAKI, Tokyo (JP); TAKUMA KOBAYASHI, Tokyo (JP); MASAHIRO YAMAZAKI, Tokyo (JP); HIROYUKI SATO, Tokyo (JP)

(21) Appl. No.: 14/761,483

(22) PCT Filed: Jan. 14, 2014
(86) PCT No.: PCT/JP2014/050461

§ 371 Date: Jul. 16, 2015

(30) Foreign Application Priority Data
Jan. 18, 2013 (JP) 2013-007374

(51) Int. Cl. C09K 8/588

(52) U.S. Cl. CPC C09K 8/588

(57) ABSTRACT

A well treatment fluid material comprising 100 parts by mass of polyester resin containing 50% by mass or more of a lactic acid resin and at least one of the degradation accelerators of 0.01 to 10 parts by mass of an organophosphorus compound and 10 to 50 parts by mass of a carboxylic acid anhydride.

### TECHNICAL FIELD

The present invention is related to a well treatment fluid material and a well treatment fluid containing the same. More specifically, the present invention is related to a degradable well treatment fluid material containing a lactic acid resin and a well treatment fluid containing the same.

### BACKGROUND ART

Aliphatic polyesters such as polyglycolic acid and polylactic acid are degraded by microorganisms or enzymes present in the natural world such as in the ground or the sea and have therefore attracted attention as biodegradable polymer materials with a small environmental burden. In addition to the biodegradability, these aliphatic polyesters have hydrolyzability and use of the aliphatic polyesters in various fields has been actively investigated in recent years.

Meanwhile, oil well and gas well are drilled to obtain petroleum and natural gas. Such drilling operations include the process of fracturing which increases the production of the petroleum and/or natural gas by boring a wellbore using a drill while mud water is circulated and then injecting fracturing fluid into a subterranean formation to create fractures. WO/2007/066254 (Patent Document 1) discloses polyesters such as polylactic acids and polyglycolic acids as degradable materials constituting such a fracturing fluid. In addition, the specification of US Patent Publication No. 2009/0025934 (Patent Document 2) discloses polylactic acids as one of the degradable materials constituting the removal agent used in fracturing.

### CITATION LIST

### Patent Literature

Patent Document 1: WO/2007/066254

Patent Document 2: US Patent Application Publication No. 2009/0025934 A1 specification

### SUMMARY OF INVENTION

### Technical Problem

Lactic acid resin shows a good degradability at high temperature (for example, 80° C. or more); however, at a comparatively low temperature (for example, less than 80° C., preferably 70° C. or less), a satisfactory degradation rate is not always exhibited.

The present invention has been made in view of the above-mentioned problems pending in the conventional art, and the objective of the invention is to provide a well treatment fluid material which requires less time for degradation even under low temperature conditions, i.e., a well treatment fluid material with superior degradability (for example, less than 80° C., preferably 70° C. or less).

### Solution to Problem

As a result of dedicated research to accomplish the above-mentioned objective, the present inventor discovered that an addition of a specific degradation accelerator to a polyester resin containing 50% by mass or more of a lactic acid resin resulted in gaining a well treatment fluid material with superior degradability at low temperature (for example, less than 80° C., preferably 70° C. or less), and thereby completed the present invention.

In other words, the well treatment fluid material of the present invention contains 100 parts by mass of polyester resin containing 50% by mass or more of a lactic acid resin and at least one of the degradation accelerators of 0.01 to 10 parts by mass of an organophosphorus compound and 10 to 50 parts by mass of a carboxylic acid anhydride.

In such a well treatment fluid material, it is preferable that the organophosphorus compound is at least one type selected from the group consisting of phosphate and phosphite. Moreover, it is more preferable that the organophosphorus compound is a compound having at least one type of the structure selected from the group consisting of a long chain alkyl group having from 8 to 24 carbons, an aromatic ring, and a pentaerythritol skeleton structure. Furthermore, it is preferable that the carboxylic acid anhydride is at least one type selected from the group consisting of hexanoic anhydride, octanoic anhydride, decanoic anhydride, lauric anhydride, myristic acid anhydride, palmitic anhydride, stearic anhydride, benzoic anhydride, succinic anhydride, maleic anhydride, phthalic anhydride, trimellitic anhydride, tetrahydrophthalic anhydride, butanetetracarboxylic dianhydride, benzophenone-3,3′,4,4′-tetracarboxylic dianhydride, diphenylsulfonetetracarboxylic dianhydride, biphenyltetracarboxylic dianhydride, ethylene glycol bisanhydrotrimellitate, and glycerin bis anhydrotrimellitate monoacetate.

In cases where the well treatment fluid material of the present invention contains the organophosphorus compound, a carboxylic acid anhydride of 1 to 50 parts by mass per 100 parts by mass of the polyester resin may further be contained.

Moreover, the well treatment fluid material of the present invention preferably is in any form of powders, pellets, films and fibers. In addition, the well treatment fluid of the present invention contains such well treatment fluid material of the present invention.

### Advantageous Effects of Invention

According to the present invention, a well treatment fluid material which requires less time for degradation even under low temperature conditions (for example, less than 80° C., preferably 70° C. or less), i.e., a well treatment fluid material with superior degradability can be obtained.

### DESCRIPTION OF EMBODIMENTS

The present invention will be described in detail hereinafter using preferred embodiments thereof.

First of all, an explanation regarding the well treatment fluid material of the present invention is given below. The well treatment fluid material of the present invention contains 100 parts by mass of polyester resin containing 50% by mass or more of a lactic acid resin and at least one of the degradation accelerators of 0.01 to 10 parts by mass of an organophosphorus compound and 10 to 50 parts by mass of a carboxylic acid anhydride.

Such well treatment fluid material of the present invention has a superior degradability at low temperature (for example, less than 80° C., preferably 70° C. or less). In specific, when 1 g of this well treatment fluid material is immersed in a 50 ml of ion exchange water and maintained for 2 weeks at 40° C. or 60° C., preferably the mass loss after being maintained is 10% or more (more preferably 15% or more, or even more preferably 20% or more).

Hereinafter, each of the components of the present invention will be described.

### Polyester Resin

The polyester resin used in the present invention contains 50% by mass or more of a lactic acid resin. The amount of the lactic acid resin contained is preferably 55% by mass or more, more preferably 70% by mass or more, even more preferably 80% by mass or more, and particularly preferably 90% by mass or more.

### (Lactic Acid Resin)

The lactic acid resin used in the present invention is a polymer having a lactic acid unit (—OCH(CH₃)—CO—). Such lactic acid resin includes polylactic acid which only consists of the lactic acid unit, and lactic acid copolymers having a constituent unit deriving from a lactic acid unit and other monomers (hereinafter referred to as “comonomers”). Examples of the polylactic acid include poly-D-lactic acid consisting only of D-lactic acid units (homopolymer of the D-lactic acid), poly-L-lactic acid consisting only of L-lactic acid units (homopolymer of the L-lactic acid), and poly-DL-lactic acid consisting of D-lactic acid units and L-lactic acid units (copolymer of the D-lactic acid and the L-lactic acid). The lactic acid copolymer is preferably a lactic acid copolymer containing at least 50 mol % of the lactic acid units per 100 mol % of total constituent units constituting the copolymer. Also in the case of lactic acid copolymers, the lactic acid units may be only D-lactic acid units, may be only L-lactic acid units, or may be a mixture of the D-lactic acid units and the L-lactic acid units.

Note that the lactic acid unit is a unit derived from a monomer that imparts a —OCH(CH₃)—CO— structure to the polymer by polymerization, and not necessarily a unit derived from lactic acid. For example, in the present invention, the lactic acid resin includes a polymer derived from lactide which is a bimolecular cyclic ester of lactic acids.

The comonomers include a mixture of a substantially equivalent mol of: for example, cyclic monomers such as glycolides, oxalic acid ethylene (i.e., 1,4-dioxane-2,3-dione), lactones (e.g., β-propiolactone, β-butyrolactone, β-pivalolactone, γ-butyrolactone, δ-valerolactone, β-methyl-δ-valerolactone, ε-caprolactone), carbonates (e.g., trimethylene carbonate); ethers (e.g., 1,3-dioxane); ether esters (e.g., dioxanone), and amides (ε-caprolactam and the like); hydroxycarboxylic acids other than lactic acids such as glycolic acid, 3-hydroxypropionic acid, 3-hydroxybutyric acid, 4-hydroxybutyric acid, 6-hydroxycaproic acid, or the alkyl esters thereof; and aliphatic diols such as ethylene glycol, 1,4-butanediol, aliphatic dicarboxylic acids such as succinic acids, adipic acid, or the alkyl esters thereof. One type of these comonomers may be used alone or two or more types of these comonomers may be used in combination.

As a lactic acid polymer, from the view point of improving the degradability of a well treatment fluid material, per 100 mol % of total constituent units constituting the copolymer, a lactic acid copolymer containing 50 mol % or more of the lactic acid units is preferable, 55 mol % or more of the lactic acid units is more preferable, 80 mol % or more of the lactic acid units is even more preferable, and 90 mol % or more of the lactic acid units is particularly preferable. Furthermore, the lactic acid resin is preferably a lactic acid homopolymer consisting only of the lactic acid units.

The average molecular weight (Mw) of the lactic acid resin is preferably from 10,000 to 800,000, more preferably from 20,000 to 600,000, further preferably from 30,000 to 400,000, and particularly preferably from 50,000 to 300,000. When the Mw of the lactic acid resin is below the lower limit, the strength of the well treatment fluid material may be insufficient. On the other hand, when the Mw of the lactic acid resin is above the upper limit, it may become difficult to mold the well treatment fluid material into a desired form due to the increase of the melt viscosity.

The production method of such a lactic acid resin is not particularly limited, and the lactic acid resin can be produced by a conventional method. Also, in the present invention, commercially available lactic acid resins can be used.

### Other Polyester Resin

In the well treatment fluid material of the present invention, the polyester resins other than the lactic acid resin (hereinafter referred to such as “other polyester resins”) may be used in combination. The amount contained of such other polyester resins may be less than 50% by mass, preferably 45% by mass or less, even more preferably 30% by mass or less, further preferably 20% by mass or less, and particularly preferably 10% by mass or less.

There is no particular restriction on the other polyester resins; however, degradable polyester resins such as glycolic acid resin, polyethylene terephthalate copolymers, polybutylene succinate, polycaprolactone, polyhydroxyalkanoate are included. One type of these degradable polyester resins may be used alone or two or more types of these degradable polyester resins may be used in combination. Among such degradable polyester resins, from the view point of improving the degradability of the well treatment fluid material, glycolic acid resin is preferable.

Glycolic acid resin is a polymer having a glycolic acid unit (—OCH₂—CO—), for example, it includes polyglycolic acid only consisting of the glycolic acid unit, i.e., glycolic acid homopolymers and glycolic acid copolymers having a constituent unit deriving from glycolic acid units and other monomers (hereinafter referred to as “comonomers”). The glycolic acid copolymer is preferably a glycolic acid copolymer containing at least 50 mol % of the glycolic acid units per 100 mol % of total constituent units constituting the copolymer.

Note that, the glycolic acid unit is a unit derived from a monomer that imparts a —OCH₂—CO— structure to the polymer by polymerization, and not necessarily a unit derived from glycolic acid. For example, in the present invention, the glycolic acid resin includes a polymer derived from glycolide which is a bimolecular cyclic ester of glycolic acids.

As for the comonomer, those exemplified as a comonomer in a lactic acid copolymer (except from glycolide and glycolic acid), lactic acid, and lactide can be provided. As glycolic acid copolymers, from the view point of improving the degradability of a well treatment fluid material, per 100 mol % of total constituent units constituting the copolymer, copolymers containing 50 mol % or more of the glycolic acid units is preferable, 55 mol % or more of the glycolic acid units is more preferable, 80 mol % or more of the glycolic acid units is even more preferable, and 90 mol % or more of the glycolic acid units is particularly preferable. Furthermore, the glycolic acid resin is preferably a glycolic acid homopolymer consisting only of the glycolic acid units.

The average molecular weight (Mw) of the glycolic acid resin is preferably from 10,000 to 800,000, more preferably from 20,000 to 600,000, further preferably from 30,000 to 400,000, and particularly preferably from 50,000 to 300,000. When the Mw of the glycolic acid resin is below the lower limit, the strength of the well treatment fluid material may be insufficient. On the other hand, when the Mw of the glycolic acid resin is above the upper limit, it may become difficult to mold the well treatment fluid material into a desired form due to the increase of the melt viscosity.

The production method of such a glycolic acid resin is not particularly limited, and the glycolic acid resin can be produced by a conventional method. Also, in the present invention, commercially available glycolic acid resins can be used.

### Degradation Accelerator

The well treatment fluid material of the present invention contains at least one of the degradation accelerators of an organophosphorus compound and a carboxylic acid anhydride. By adding at least one of the organophosphorus compound and carboxylic acid anhydride as a degradation accelerator, a well treatment fluid material with superior degradability at low temperature (for example, less than 80° C., preferably 70° C. or less) can be obtained.

### (Organophosphorus Compound)

There is no particular limitation on the organophosphorus compound used in the present invention; however, phosphate and phosphite are preferred. In particular, an organophosphorus compound having at least one type of the structure selected from the group consisting of a long chain alkyl group having from 8 to 24 carbons, an aromatic ring, and a pentaerythritol skeleton structure is more preferred. These organophosphorus compounds can be used alone or two or more types of these organophosphorus compounds can be used in combination.

Examples of the phosphate having a long-chain alkyl group having from 8 to 24 carbons include mono- or di-stearyl acid phosphate or a mixture thereof, di-2-ethylhexyl acid phosphate, and the like. Examples of the phosphite having an aromatic ring include tris(nonylphenyl)phosphite and the like. Examples of the phosphite having a pentaerythritol skeleton structure include cyclic neopentanetetraylbis(2,6-di-tert-butyl-4-methylphenyl)phosphite, cyclic neopentanetetraylbis(2,4-di-tert-butylphenyl)phosphite, cyclic neopentanetetraylbis(octadecyl)phosphite, and the like.

### Carboxylic Acid Anhydride

There is no particular limitation on the carboxylic acid anhydride used in the present invention; however, from the view point of heat resistance that can tolerate the temperature of when the well treatment fluid material of the present invention is molded into a desired form as well as from the view point of compatibility with the lactic acid resin composition, the following is preferred: aliphatic monocarboxylic acid anhydrides (preferably those having 2 alkyl groups having from 6 to 20 carbons) such as hexanoic anhydride, octanoic anhydride, decanoic anhydride, lauric anhydride, myristic acid anhydride, palmitic anhydride, and stearic anhydride; aromatic monocarboxylic acid anhydrides such as benzoic anhydride; aliphatic dicarboxylic acid anhydrides (preferably those having saturated or unsaturated hydrocarbon chains with 2 to 20 carbon atoms) such as succinic anhydride, maleic anhydride; aromatic dicarboxylic acid anhydrides such as phthalic anhydride; aromatic tricarboxylic acid anhydride such as trimellitic anhydride; alicyclic dicarboxylic acid anhydrides such as tetrahydrophthalic anhydride; aliphatic tetracarboxylic dianhydride such as butanetetracarboxylic dianhydride; and aromatic tetracarboxylic dianhydride such as benzophenone-3,3′,4,4′-tetracarboxylic dianhydride, diphenylsulfonetetracarboxylic dianhydride, biphenyltetracarboxylic dianhydride, ethylene glycol bisanhydrotrimellitate, and glycerin bis anhydrotrimellitate monoacetate. Furthermore, a carboxylic anhydride with a ring structure is more preferred. Furthermore, aromatic monocarboxylic anhydride, aromatic dicarboxylic anhydride, aromatic tricarboxylic anhydride, and aromatic tetracarboxylic dianhydride are further preferred. In addition, phthalic anhydride, trimellitic anhydride, benzophenone-3,3′,4,4′-tetracarboxylic dianhydride are particularly preferred. One type of these carboxylic acid anhydrides may be used alone or two or more types of these carboxylic acid anhydrides may be used in combination.

### <A Well Treatment Fluid Material>

The well treatment fluid material of the present invention contains, per 100 parts by mass of the polyester resin, at least one of the degradation accelerators of 0.01 to 10 parts by mass of an organophosphorus compound and 10 to 50 parts by mass of a carboxylic acid anhydride.

When the amount contained of the organophosphorus compound and carboxylic acid anhydride is below the lower limit, the degradability at low temperature (for example, less than 80° C., preferably 70° C. or less) is not sufficiently exhibited. On the other hand, when the amount contained of the organophosphorus compound is above the upper limit, it tends to result in the reduction of molecular weight at the time of molding and processing, and in the degradation of surface quality due to bleed out. Moreover, from the view point of improving degradability of the well treatment fluid material at a low temperature, the amount contained of the organophosphorus compound is preferably 0.1 to 10 parts by mass, or even more preferably, 0.5 to 10 parts by mass, per 100 parts by mass of the polyester resin mentioned above. On the other hand, when the amount contained of the carboxylic acid anhydride exceeds the upper limit, it would become difficult to form the well treatment fluid material into a desired form. Due to a further facility in molding the well treatment fluid material into a desired form, the amount contained of the carboxylic acid anhydride is preferably 10 to 40 parts by mass, and more preferably 10 to 30 parts by mass per 100 parts by mass of the polyester resin.

Moreover, in case where the well treatment fluid material of the present invention contains a predetermined amount of organophosphorus compound, a carboxylic acid anhydride of 1 to 50 parts by mass may further be contained in the 100 parts by mass of the polyester resin.

In general, when a lactic acid resin is degraded, the amount of the carboxyl group in that system will increase, and thus, the pH of that system decreases. When conventionally known acids (for example, carboxylic acid), inorganic substances, and the like are used as an additive to accelerate the degradation of the well treatment fluid material comprising a lactic acid resin, a low pH in the initial stage of that system is observed. When an acid which is not an anhydride is used as a degradation accelerator, it tends to be that the degradation of the lactic acid resin is accelerated in the initial stage of the well treatment resulting in the reduction of strength of the well treatment fluid material. On the other hand, in the present invention, as the carboxylic acid anhydride is used as a degradation accelerator, the pH in the initial stage of the system is higher than when an acid which is not an anhydride is used, for example. That is to say that in the well treatment fluid material of the present invention, as the degradation of the lactic acid resin in the initial stage of the well treatment is suppressed, the strength of the well treatment fluid material is assured to be sufficient. In comparison to the conventional degradation accelerators (i.e., degradation accelerators other than carboxylic acid anhydrides and phosphorus compounds), carboxylic acid anhydrides suppress the degradation of the resin due to reaction of carboxylic acid anhydrides and absorption of water under environments where less water is present. For this reason, the well treatment fluid material of the present invention can still keep its superior degradability under environments where water is abundant, but can also suppress the degradation of lactic acid resin under environments where less water is present as in the preparation or storage of the well treatment fluid material of the present invention.

A conventionally known thermal stabilizer may be contained in the well treatment fluid material of the present invention for preventing heat degradation when molding and processing the material to a desired form. Examples of such a thermal stabilizer include metal carbonates such as calcium carbonate and strontium carbonate; hydrazine compounds typically known as polymerization catalyst deactivators having —CONHNH—CO— units such as bis[2-(2-hydroxybenzoyl)hydrazine]dodecanoic acid and N,N′-bis[3-(3,5-di-t-butyl-4-hydroxyphenyl)propionyl]hydrazine; triazole compounds such as 3-(N-salicyloyl)amino-1,2,4-triazole; triazine compounds; and the like. The amount contained of the thermal stabilizer is generally 3 parts by mass or less, preferably, 0.001 to 1 parts by mass, more preferably, 0.005 to 0.5 parts by mass, and particularly preferably 0.01 to 0.1 parts by mass (100 to 1000 ppm), per 100 parts by mass of the polyester resin.

Additionally, in the well treatment fluid material of the present invention, a conventionally known carboxyl group-end capping agent or hydroxyl group-end capping agent may be formulated to improve the preserving property. Examples of such an end capping agent are not particularly limited as long as the compound has a carboxyl group-end capping effect and hydroxyl group-end capping effect. Examples of the carboxyl group-end capping agent include carbodiimide compounds such as N,N-2,6-diisopropyl phenyl carbodiimide; oxazoline compounds such as 2,2′-m-phenylene bis(2-oxazoline), 2,2′-p-phenylene bis(2-oxazoline), 2-phenyl-2-oxazoline, and styrene-isopropenyl-2-oxazoline; oxazine compounds such as 2-methoxy-5,6-dihydro-4H-1,3-oxazine; epoxy compounds such as N-glycidyl phthalimide, cyclohexene oxide, and tris(2,3-epoxypropyl)isocyanurate; and the like. Among these carboxyl group-end capping agents, carbodiimide compound is preferable. Although any of aromatic, alicyclic, and aliphatic carbodiimide compounds can be used, aromatic carbodiimide compound is particularly preferable, and specifically, a compound with high purity is excellent at enhancing the storage properties. In addition, examples of the hydroxyl group-end capping agent include diketene compounds, isocyanates, and the like. The compounded amount of such an end capping agent is typically from 0.01 to 5 parts by mass, preferably from 0.05 to 3 parts by mass, and more preferably from 0.1 to 1 part by mass, per 100 parts by mass of the polyester resin.

Furthermore, the well treatment fluid material of the present invention preferably includes, as an optional component, resins other than polyester resins, thermal stabilizer, light stabilizer, inorganic fillers, organic fillers, plasticizer, nucleating agent, desiccating agent, water proof agent, water repellant agent, and lubricant.

As resins other than the polyester resins, resins that are degradable such as polyamide, polyester amide, polyether, polysaccharide, polyvinyl alcohol are preferred. Such resins other than polyester resins are preferably formulated so that the lactic acid resin contained in the polyester resin would be 99 to 50 parts by mass and the resins other than polyester resin would be 1 to 50 parts by mass per a total of 100 parts by mass of these resins other than polyester resins and the polyester resin.

There is no particular limitation on the method for producing the well treatment fluid material of the present invention; however, a method for obtaining the well treatment fluid material of the present invention includes, for example, a method which comprises mixing polyester resin comprising a lactic acid resin and if necessary other polyester resins, at least one of carboxylic anhydride and organophosphorus compound which are degradation accelerators, and if necessary, thermal stabilizers, end capping agents, and other optional components; performing melting and kneading at or above a melt temperature of the lactic acid resin; and directly molding it into a desired form, or a method which comprises molding into a pellet from the melted and kneaded product, and then performing secondary molding this pellet to a desired form. As for the form of the well treatment fluid material of the present invention, for example, powders, pellets, films, and fibers are included.

When an organophosphorus compound is included as a degradation accelerator, a well treatment fluid material superior in the degradation property as compared to when an inorganic phosphorous compound is included can be obtained. Moreover, when carboxylic acid anhydride is included as a degradation accelerator, there is an advantage that it decreases the occurrence of the reduction of the molecular weight of the lactic acid resin resulting from melting and kneading as compared to when a conventional carboxylic acid degradation accelerator such as common carboxylic acid (i.e., degradation accelerator other than carboxylic acid anhydride) is contained.

Such well treatment fluid material can be used as a sealer in the fracturing fluid, proppant dispersant in the fracturing fluid, pH adjusting agent in a variety of well treatment fluid, and the like.

### <Well-Treatment Fluid>

The well treatment fluid of the present invention is a fluid containing the well treatment fluid material of the present invention. Such a well treatment fluid includes various liquid fluids used in the well drilling of petroleum or natural gas. For example, it can be used as at least one type of a well treatment fluid selected from the group consisting of a drilling fluid, a fracturing fluid, cementing fluid, a temporary plug fluid, and a completion fluid.

In such a well treatment fluid, as the well treatment fluid material of the present invention, in general, those in the form of powders, pellets, films, fibers, and the like are used. Examples of the powder include powder having a ratio of major axis/minor axis of 1.9 or less, and a 50 wt. % cumulative mean diameter of 1 to 1000 μm. Examples of the pellet include a pellet having a length in the longitudinal direction of 1 to 10 mm, and an aspect ratio of 1 or greater and less than 5. Examples of the film include a film piece having an area of 0.01 to 10 cm², and a thickness of 1 to 1000 μm. Examples of the fiber include a short fiber having a ratio of length/cross-sectional diameter (aspect ratio) of 10 to 2000, and a minor axis of 5 to 95 μm.

The well treatment fluid material of the present invention, for example, in case of formulating it into a fracturing fluid as a fiber, allowing the fiber to be contained in the fracturing fluid at a concentration of 0.05 to 100 g/L or preferably 0.1 to 50 g/L, may improve the dispersibility of the proppant.

The well treatment fluid material contained in the well treatment fluid may become functionally unnecessary during the production of the well and/or upon the completion of the production of the well. Nonetheless, with the well treatment fluid material of the present invention, the recovery or disposal which is generally required will be unnecessary or easy. That is to say that the well treatment fluid material of the present invention is superior in the biodegradability and hydrolyzability, and for example, even it would be left in the fracture and the like formed in the ground, it would be biodegraded by the microorganisms present in the soil or hydrolyzed by the moisture in the soil and disappears in a short period time which results in not requiring a recovery process. In particular, the well treatment fluid material of the present invention would exhibit a superior degradability not only at high temperature (for example, 80° C. or more) but also at a low temperature (for example, less than 80° C., preferably 70° C. or less). Therefore, it disappears in a short period of time not only in a high temperature high pressure soil environment but also in a relatively low temperature soil environment. Moreover, depending on the conditions, the injection of an alkaline solution to the ground where the well treatment fluid material of the present invention is still remaining allows the contact of the alkaline solution with the well treatment fluid material, and thereby hydrolysis in a short period of time can be performed. Furthermore, when the well treatment fluid material of the present invention is collected above ground along with the fracturing fluid, it can be easily (at a relatively low temperature) biodegraded or hydrolyzed.

Furthermore, the well treatment fluid material of the present invention would exhibit a superior hydrolyzability not only at high temperature (for example, 80° C. or more) but also at a low temperature (for example, less than 80° C., preferably 70° C. or less). Therefore, when it becomes functionally unnecessary, even when it is collected above ground, it can be hydrolyzed in a short period of time for disappearance at a relative low temperature. Moreover, it can also be hydrolyzed in a short period of time for disappearance in a soil environment not only at a high temperature and high pressure but also in a soil environment at a relative low temperature. Moreover, the well treatment fluid material of the present invention has an acid releasing property, and acid treatment which can be adopted in well production, i.e., performing a treatment by contacting acids and oil layers and the like, facilitates the fracturing of rocks and can also have an advantageous effect in well stimulation method which increases the permeation rate of the oil layer by dissolving the rocks.

The well treatment fluid of the present invention can contain various components and additives apart from the well treatment fluid material of the present invention that are generally contained in the well treatment fluid. For example, the fracturing fluid used in hydraulic fracturing can contain, in addition to the well treatment fluid material of the present invention (for example, at a concentration of 0.05 to 100 g/L), water and organic solvents as principle components (approximately 90 to 95% by mass) as a solvent or disperse medium, as well as, sand, glass beads, ceramic particles, resin coated sand, and the like as a proppant (approximately 5 to 9% by mass). Furthermore, it can contain various additives (approximately 0.5 to 1% by mass) such as gelling agent, scale preventing agent, acids for dissolving rocks, friction reducing agent, and the like. The well treatment fluid containing the well treatment fluid material of the present invention, for example, the well treatment fluid containing the fibrous well treatment fluid material of the present invention at a concentration of 0.05 to 100 g/L has a superior property as a well treatment fluid of a drilling fluid, a fracturing fluid, a cementing fluid, a temporary plug fluid and a completion fluid, and it exerts an effect in that the recovery or disposal after use is extraordinary easy.

### EXAMPLES

The present invention will be described in further detail hereinafter based on working examples and comparative examples, but the present invention is not limited to the following examples. The properties of the resin used and the well treatment fluid material obtained in the examples were determined by the following methods.

### <Measurement of Molecular Weight>

The molecular weight of resin (polylactic acid, polyglycolic acid, and the like) has been determined using the gel permeation chromatography (GPC) with the following conditions.

### GPC Measurement Conditions

Device: Shodex-104, manufactured by Showa Denko K.K.
Columns: two HFIP-606M and, as a precolumn, one HFIP-G were connected in series

### Column Temperature: 40° C.

Eluant: hexafluoroisopropanol (HFIP) solution in which 5 mM of sodium trifluoroacetate was dissolved
Flow rate: 0.6 mL/min
Detector: RI (differential refractive index) detector
Molecular weight calibration: five types of standard polymethylmethacrylates having different molecular weights were used.

### <Degradation Test (Measurement of Mass Loss)>

One gram of the sample (the well treatment fluid material or polylactic acid) was immersed in 50 ml of ion exchange water in a glass container which was maintained in an incubator at 40° C. or 60° C. for 2 weeks. Then, gravity filtration was performed and the solid component which remained on the filter paper was allowed to stay at room temperature for 1 day, which was then dried under nitrogen atmosphere at 80° C. The mass of the solid component after drying was measured and the ratio to the mass (1 g) of the sample before maintaining at 40° C. or 60° C. (the mass loss after maintaining at 40° C. or 60° C. for 2 weeks) was calculated.

### Working Example 1

To 100 parts by mass of polylactic acid (PLA, Manufactured by Nature Works, “PLA polymer 4032D”, average molecular weight (Mw): 256,000), 0.1 parts by mass of di-2-ethylhexyl acid phosphate (“Phoslex A-208” manufactured by Sakai Chemical Industry Co., Ltd) was formulated. Then, this was provided to the feed part of the biaxial extrusion kneader (Togo Seiki Co., Ltd. “2D25S”) whose temperature of the screw part was set at 200 to 240° C. to perform melt-kneading, and a pellet form well treatment fluid material was obtained. Then, this well treatment fluid material was subjected to a degradation test according to the above-mentioned method and the mass loss after maintaining at 60° C. for 2 weeks was calculated. The results are shown in Table 1.

### Working Examples 2 to 3

A pellet form well treatment fluid material was prepared in the same manner as in Working Example 1 other than the amount of formulation of di-2-ethylhexyl acid phosphate was modified to the amount in Table 1. Then, this obtained well treatment fluid material was subjected to a degradation test according to the above-mentioned method and the mass loss after maintaining at 60° C. for 2 weeks was calculated. The results are shown in Table 1.

### Working Example 4

A pellet form well treatment fluid material was prepared in the same manner as in Working Example 1 other than that 1 part by mass of distearyl pentaerythritol diphosphate (cyclicneopentanetetraylbis(octadecyl)phosphite, “ADK STAB PEP-8” manufactured by ADEKA corporation) was formulated instead of di-2-ethylhexyl acid phosphate. The obtained well treatment fluid material was subjected to a degradation test according to the above-mentioned method and the mass loss after maintaining at 60° C. for 2 weeks was calculated. The results are shown in Table 1.

### Working Example 5

A pellet form well treatment fluid material was prepared in the same manner as in Working Example 4 other than that the amount of formulation of distearyl pentaerythritol diphosphate was modified to the amount shown in Table 1. Then, this obtained well treatment fluid material was subjected to a degradation test according to the above-mentioned method and the mass loss after maintaining at 60° C. for 2 weeks was calculated. The results are shown in Table 1.

### Working Example 6

A pellet form well treatment fluid material was prepared in the same manner as in Working Example 1 other than that 5 parts of bis(2,6-di-tert-butyl-4-methylphenoxy)-2,4,8,10-tetraoxa-3,9-diphosphaspiro[5.5]undecane (cyclic neopentane tetra-yl bis(2,6-di-tert-butyl-4-methylphenyl)phosphite, “ADK STAB PEP-36” manufactured by ADEKA corporation) was formulated instead of di-2-ethylhexyl acid phosphate. Then, this obtained well treatment fluid material was subjected to a degradation test according to the above-mentioned method and the mass loss after maintaining at 60° C. for 2 weeks was calculated. The results are shown in Table 1.

### Working Examples 7 to 9

In each of the Working Examples, a pellet form well treatment fluid material was prepared in the same manner as in Working Example 1 other than that 1 part by mass, 3 parts by mass, or 5 parts by mass, respectively, of 3,3′,4,4′-benzophenone tetracarboxylic dianhydride (BTDA) were further formulated. Then, this obtained well treatment fluid material was subjected to a degradation test according to the above-mentioned method and the mass loss after maintaining at 60° C. for 2 weeks was calculated. The results are shown in Table 1.

### Working Examples 10 to 12

In each of the Working Examples, a pellet form well treatment fluid material was prepared in the same manner as in Working Example 2 other than that 1 part by mass, 3 parts by mass, or 5 parts by mass, respectively, of BTDA were further formulated. Then, this obtained well treatment fluid material was subjected to a degradation test according to the above-mentioned method and the mass loss after maintaining at 60° C. for 2 weeks was calculated. The results are shown in Table 1.

### Working Example 13

A pellet form well treatment fluid material was prepared in the same manner as in Working Example 1 other than that 10 parts by mass of BTDA was formulated instead of di-2-ethylhexyl acid phosphate. Then, the obtained well treatment fluid material was subjected to a degradation test according to the above-mentioned method and the mass loss after maintaining at 40° C. for 2 weeks was calculated. The results are shown in Table 1.

### Working Example 14

A pellet form well treatment fluid material was prepared in the same manner as in Working Example 13 other than that the amount of formulation of BTDA was modified to the amount shown in Table 1. Then, this obtained well treatment fluid material was subjected to a degradation test according to the above-mentioned method and the mass loss after maintaining at 40° C. for 2 weeks was calculated. The results are shown in Table 1.

### Working Examples 15 to 16

In each of the Working Examples, a pellet form well treatment fluid material was prepared in the same manner as in Working Example 13 other than that 10 parts by mass and 30 parts by mass, respectively, of phthalic anhydride was formulated instead of BTDA. Then, this obtained well treatment fluid material was subjected to a degradation test according to the above-mentioned method and the mass loss after maintaining at 40° C. for 2 weeks was calculated. The results are shown in Table 1.

### Working Examples 17 to 18

In each of the Working Examples, a pellet form well treatment fluid material was prepared in the same manner as in Working Example 13 other than that 10 parts by mass and 30 parts by mass, respectively, of trimellitic anhydride was formulated instead of BTDA. Then, this obtained well treatment fluid material was subjected to a degradation test according to the above-mentioned method and the mass loss after maintaining at 40° C. for 2 weeks was calculated. The results are shown in Table 1.

### Working Example 19

A pellet form well treatment fluid material was prepared in the same manner as in Working Example 13 other than that 90 parts by mass of PLA and 10 parts by mass of polyglycolic acid (PGA, “Kuredux”, average molecular weight (Mw); 176,000, manufactured by Kureha Corporation) were formulated instead of 100 parts of PLA. Then, this obtained well treatment fluid material was subjected to a degradation test according to the above-mentioned method and the mass loss after maintaining at 40° C. or 60° C. for 2 weeks was calculated for each. The results are shown in Table 1.

### Working Examples 20 to 21

A pellet form well treatment fluid material was prepared in the same manner as in Working Example 19 other than that the amount of formulation of PLA and PGA was modified to the respective amounts shown in Table 1. Then, this obtained well treatment fluid material was subjected to a degradation test according to the above-mentioned method and the mass loss after maintaining at 40° C. or 60° C. for 2 weeks was calculated for each. The results are shown in Table 1.

### Comparative Example 1

A pellet form polylactic acid was prepared in the same manner as in Working Example 1 other than that di-2-ethylhexyl acid phosphate was not formulated. Then, this obtained polylactic acid was subjected to a degradation test according to the above-mentioned method and the mass loss after maintaining at 40° C. or 60° C. for 2 weeks was calculated. The results are shown in Table 1.

### Comparative Examples 2 to 4

A pellet form well treatment fluid material was prepared in the same manner as in Working Example 1 other than that 0.5 parts by mass of tricalcium phosphate (Ca₃(PO₄)₂) (Comparative Example 2); calcium bis dihydrogenphosphate (Ca(H₂PO₄)₂) (Comparative Example 3), or aluminum phosphate (AlPO₄) (Comparative Example 4) were formulated instead of di-2-ethylhexyl acid phosphate. Then, this obtained well treatment fluid material was subjected to a degradation test according to the above-mentioned method and the mass loss after maintaining at 40° C. or 60° C. for 2 weeks was calculated. The results are shown in Table 1.

TABLE 1

| | Polyester resin | | Phosphorus compound | |
|---|---|---|---|---|
| | | Compounded | | Compounded |
| | | amount | | amount |
| | | (parts by | | (parts by |
| | Type | mass) | Type | mass) |
| Working | PLA | 100 | A-208 | 0.1 |
| Example 1 | | | | |
| Working | PLA | 100 | A-208 | 0.5 |
| Example 2 | | | | |
| Working | PLA | 100 | A-208 | 1.0 |
| Example 3 | | | | |
| Working | PLA | 100 | PEP-8 | 1 |
| Example 4 | | | | |
| Working | PLA | 100 | PEP-8 | 3 |
| Example 5 | | | | |
| Working | PLA | 100 | PEP-36 | 5 |
| Example 6 | | | | |
| Working | PLA | 100 | A-208 | 0.1 |
| Example 7 | | | | |
| Working | PLA | 100 | A-208 | 0.1 |
| Example 8 | | | | |
| Working | PLA | 100 | A-208 | 0.1 |
| Example 9 | | | | |
| Working | PLA | 100 | A-208 | 0.5 |
| Example 10 | | | | |
| Working | PLA | 100 | A-208 | 0.5 |
| Example 11 | | | | |
| Working | PLA | 100 | A-208 | 0.5 |
| Example 12 | | | | |
| Working | PLA | 100 | — | — |
| Example 13 | | | | |
| Working | PLA | 100 | — | — |
| Example 14 | | | | |
| Working | PLA | 100 | — | — |
| Example 15 | | | | |
| Working | PLA | 100 | — | — |
| Example 16 | | | | |
| Working | PLA | 100 | — | — |
| Example 17 | | | | |
| Working | PLA | 100 | — | — |
| Example 18 | | | | |
| Working | PLA | 90 | — | — |
| Example 19 | PGA | 10 | — | — |
| Working | PLA | 70 | — | — |
| Example 20 | PGA | 30 | — | — |
| Working | PLA | 50 | — | — |
| Example 21 | PGA | 50 | | |
| Comparative | PLA | 100 | — | — |
| Example 1 | | | | |
| Comparative | PLA | 100 | Ca₃(PO₄)₂ | 0.5 |
| Example 2 | | | | |
| Comparative | PLA | 100 | Ca(H₂PO₄)₂ | 0.5 |
| Example 3 | | | | |
| Comparative | PLA | 100 | AIPO₄ | 0.5 |
| Example 4 | | | | |

| | Carboxylic acid | | Mass loss | Mass loss |
|---|---|---|---|---|
| | | Compounded | (%) (after | (%) (after |
| | | amount | maintained | maintained |
| | | (parts by | at 40° C. | at 60° C. |
| | Type | mass) | for 2 weeks) | for 2 weeks) |
| Working | — | — | — | 14 |
| Example 1 | | | | |
| Working | — | — | — | 23 |
| Example 2 | | | | |
| Working | — | — | — | 25 |
| Example 3 | | | | |
| Working | — | — | — | 13 |
| Example 4 | | | | |
| Working | — | — | — | 13 |
| Example 5 | | | | |
| Working | — | — | — | 20 |
| Example 6 | | | | |
| Working | BTDA | 1 | — | 10 |
| Example 7 | | | | |
| Working | BTDA | 3 | — | 13 |
| Example 8 | | | | |
| Working | BTDA | 5 | — | 13 |
| Example 9 | | | | |
| Working | BTDA | 1 | — | 18 |
| Example 10 | | | | |
| Working | BTDA | 3 | — | 21 |
| Example 11 | | | | |
| Working | BTDA | 5 | — | 22 |
| Example 12 | | | | |
| Working | BTDA | 10 | 10 | — |
| Example 13 | | | | |
| Working | BTDA | 30 | 25 | — |
| Example 14 | | | | |
| Working | Phthalic | 10 | 10 | — |
| Example 15 | anhydride | | | |
| Working | Phthalic | 30 | 26 | — |
| Example 16 | anhydride | | | |
| Working | Trimellitic | 10 | 12 | — |
| Example 17 | acid | | | |
| | anhydride | | | |
| Working | Trimellitic | 30 | 24 | — |
| Example 18 | acid | | | |
| | anhydride | | | |
| Working | BTDA | 10 | 10 | 19 |
| Example 19 | | | | |
| Working | BTDA | 10 | 17 | 28 |
| Example 20 | | | | |
| Working | BTDA | 10 | 23 | 46 |
| Example 21 | | | | |
| Comparative | — | — | <5 | <10 |
| Example 1 | | | | |
| Comparative | — | — | <10 | <10 |
| Example 2 | | | | |
| Comparative | — | — | <10 | <10 |
| Example 3 | | | | |
| Comparative | — | — | <10 | <10 |
| Example 4 | | | | |

The mass loss of the Comparative Examples 1 to 4 shown as “<5” and “<10” each represents “less than 5%” and “less than 10%”

As it is obvious from the results shown in Table 1, when a predetermined amount of organophosphorus compound is added to a polyester resin containing 50% by mass of polylactic acid (Working Examples 1 to 12), the degradability at 60° C. improves (mass loss increases) as compared to when only polylactic acid is used (Comparative Example 1) or when inorganic phosphorous compound is added (Comparative Examples 2 to 4).

Furthermore, when a predetermined amount of carboxylic anhydride is added to a polyester resin containing 50% by mass or more of polylactic acid (Working Examples 13 to 21), the degradability at 40° C. improves (mass loss increases) as compared to when only polylactic acid is used (Comparative Example 1).

### INDUSTRIAL APPLICABILITY

As explained above, in accordance to the present invention, the degradation of a polyester resin containing 50% by mass or more of lactic acid resin can be performed at a relatively low temperature (for example, less than 80° C., preferably 70° C. or less).

Therefore, as the well treatment fluid material of the present invention has a superior degradability at a relatively low temperature, it is useful in a variety of well treatment fluid material such as a sealer, proppant dispersant, pH adjusting agent, suitable of drilling petroleum and natural gas not only at high temperature (for example, 80° C. or more) but also at low temperature (for example, less than 80° C., preferably 70° C. or less).

1. A well treatment fluid material comprising:
100 parts by mass of a polyester resin containing 50% by mass or more of a lactic acid resin; and
at least one of the degradation accelerators of 0.01 to 10 parts by mass of an organophosphorus compound and 10 to 50 parts by mass of a carboxylic acid anhydride.

2. The well treatment fluid material according to claim 1, wherein the organophosphorus compound is at least one type selected from the group consisting of phosphate and phosphite.

3. The well treatment fluid material according to claim 2, wherein the organophosphorus compound is a compound having at least one type of structure selected from the group consisting of a long chain alkyl group having from 8 to 24 carbons, an aromatic ring, and a pentaerythritol skeleton structure.

4. The well treatment fluid material according to claim 1, wherein the carboxylic acid anhydride is at least one type selected from the group consisting of aliphatic monocarboxylic acid anhydride, aromatic mono carboxylic anhydride, aliphatic dicarboxylic anhydride, aromatic dicarboxylic anhydride, aromatic tricarboxylic anhydride, alicyclic dicarboxylic acid anhydride, aliphatic tetracarboxylic dianhydride, and aromatic tetracarboxylic dianhydride.

5. The well treatment fluid material according to claim 1, wherein the well treatment fluid material containing the organophosphorus compound further comprises 1 to 50 parts by mass of carboxylic acid anhydride per 100 parts by mass of polyester resin.

6. The well treatment fluid material according to claim 1 in any form of powder, pellet, film and fiber.

7. A well treatment fluid comprising the well treatment fluid material described in claim 1.
